(19) United States
(12) Patent Application Publication
(10) Pub. No.: US 2026/0074904 A1
(43) Pub. Date: Mar. 12, 2026

(54) SYSTEMS AND METHODS FOR ACCESS TO ACCESS-CONTROLLED RESOURCES USING DIGITAL KEYS

(71) Applicant: Skeleton Key Systems, LLC, Northfield, NJ (US)

(72) Inventors: Adam Phillip TREISER, Washington, DC (US); Michael BURNS, Margate, NJ (US); Eric GOLDBERG, Linwood, NJ (US)

(73) Assignee: Skeleton Key Systems, LLC, Northfield, NJ (US)

(21) Appl. No.: 19/323,875

(22) Filed: Sep. 9, 2025

Related U.S. Application Data
(60) Provisional application No. 63/692,305, filed on Sep. 9, 2024.

(51) Int. Cl. H04L 9/32; H04L 9/40

(52) U.S. Cl. CPC H04L 9/3213; H04L 63/10

(57) ABSTRACT

Systems and methods control access across access systems. A reader receives a token from a user authenticator, and permission is determined by validating the token. When permitted, a digital key bound to a target resource is generated. A receiver of an access system obtains and verifies the digital key—optionally offline—and actuates the access system to perform an authorized operation. The token may include a first identifier portion usable by a first access system and an appended extension portion encoding data usable by one or more additional access systems. Extensions may be written or removed via a server-supplied amendment package or a locally unlocked package on a device or a first or third-party application, thereby augmenting or revoking privileges while preserving usability of the token by the first access system. The approach applies to locks, enclosures, compartments, devices, vehicles, and other access-controlled resources.

### CROSS-REFERENCE TO RELATED APPLICATIONS

This application claims the benefit of U.S. Provisional Patent Application No. 63/692,305, filed on Sep. 9, 2024.

### BACKGROUND OF THE INVENTION

Many environments use access-controlled systems to protect items and spaces while permitting convenient user interaction. Users often carry pre-existing credentials (e.g., hotel key cards, QR/barcode tickets, employee badges, wallet passes, or app tokens). These credentials are widely deployed and are usable by installed readers and back-end validators. However, they typically authorize only a particular zone or item and are not readily extendable to additional locks, compartments, devices, or areas. Extending them to control additional resources often requires staff intervention, continuous network connectivity, or costly hardware or software replacements. Additionally, many deployed systems lack the capacity to store large user lists or to protect sensitive data. Furthermore, these systems may need to function offline, and imposing online dependencies can increase cost and complexity.

Compatibility and security requirements also tend to conflict. Operators seek per-resource permissions with time/usage limits, replay resistance, and rapid addition or revocation of privileges, ideally without modifying existing parsers. They may also wish to manage capabilities on a user's device, including via third-party applications, even when network access is unavailable. In many deployments, it is desirable to perform access operations without exposing user identifiers or financial information to readers, receivers, or other edge devices, and without embedding such data in issued digital keys.

### SUMMARY OF THE INVENTION

The present disclosure may be directed, in an aspect, to a system for amending one or more authorization states of a user authenticator. The system comprises a user authenticator and a device. The user authenticator provides a user with first access rights to a first resource, access to the first resource being limited by a first access system. The device comprises one or more processors and memory storing instructions that, when executed by the one or more processors, cause the device to: (i) receive data indicative of a user's altered access rights with respect to a second resource, access to the second resource being limited by a second access system distinct from the first access system; and (ii) write the data to the user authenticator, or cause the data to be written to the user authenticator, to provide the user authenticator with the altered access rights with respect to the second resource. The user authenticator is configured to store the data. Upon presentation of the user authenticator to the second access system, the user authenticator provides the user access rights to the second resource in accordance with the altered access rights. After the writing of the data to the user authenticator, the user authenticator continues to provide the user with the first access rights to the first resource.

The present disclosure may be directed, in an aspect, to a computer-implemented method for amending one or more authorization states of a user authenticator. The method comprises: providing, with a user authenticator, a user with first access rights to a first resource limited by a first access system; receiving data indicative of the user's altered access rights with respect to a second resource limited by a second access system distinct from the first access system; and writing the data to the user authenticator, or causing the data to be written to the user authenticator, to provide the user authenticator with the altered access rights with respect to the second resource. The user authenticator stores the data. Upon presentation of the user authenticator to the second access system, the user authenticator provides the user access rights to the second resource in accordance with the altered access rights. After the writing of the data to the user authenticator, the user authenticator continues to provide the user the first access rights to the first resource.

The present disclosure may be directed, in an aspect, to a system for digitally providing access to an article. The system comprises a validation server, a reader, a product vending apparatus, a receiver, and a digital key server. The validation server is configured to: store user identifiers for different users; and for each of the user identifiers, store an association between the user identifier and a corresponding user authenticator. The reader is in electrical communication with the validation server and configured to read the user authenticators. The product vending apparatus is associated with the reader, the product vending apparatus comprising locks configured to secure products in a locked state. Each lock is configured to secure a corresponding one of the products, and each lock is alterable in its state between the locked state and an unlocked state. The receiver is in electrical communication with the product vending apparatus. The digital key server is configured to: receive one or more messages indicating: that a first user authenticator of the user authenticators was read by the reader, the first user authenticator being associated with a first user of the different users; that the first user is requesting to alter the state of a first lock of the locks; confirm that the first user associated with the first user authenticator has permission to access a first product of the products; create a digital key that is associated with the first lock and the first user authenticator; and transmit the digital key to the receiver. The receiver is configured to, based on the digital key, instruct a control circuit of the first lock to alter the state of the first lock.

The present disclosure may be directed, in an aspect, to a method for digitally providing access to an article. The method comprises: storing user identifiers for different users; for each of the user identifiers, storing an association between the user identifier and a corresponding user authenticator; receiving one or more messages indicating that a first user authenticator of the user authenticators was read by a reader, the first user authenticator being associated with a first user of the different users; receiving one or more messages indicating that the first user is requesting to alter the state of a first lock of locks. The locks form part of a product vending apparatus, and the locks secure products in a locked state. Each lock is configured to secure a corresponding one of the products, and each lock is alterable in its state between the locked state and an unlocked state. The method further comprises: confirming that the first user associated with the first user authenticator has permission to access a first product of the products; creating a digital key that is associated with the first lock and the first user authenticator; transmitting the digital key to a receiver; and the receiver, based on the digital key, instructing a control circuit of the first lock to alter the state of the first lock.

According to yet another aspect, the present disclosure may be directed to a server comprising one or more processors and memory storing instructions which, when executed, cause the server to: receive, from a reader that reads a token from a user authenticator, (i) the token and (ii) an associated request to perform an access operation with respect to a second resource limited by a second access system distinct from a first access system, the token comprising a first identifier portion usable by the first access system and an extension portion including one or more access descriptors; determine that the request is permitted based on one or more of: (A) permission data retrieved from a validation server, (B) validation of the token, and (C) selection of an access descriptor whose resource identifier identifies the second resource and whose validity data authorizes the access operation; in response to determining that the request is permitted, generate a digital key associated with the second resource; and transmit the digital key to a receiver of the second access system, the digital key being configured to cause the second access system to perform the access operation with respect to the second resource.

According to yet another aspect, the present disclosure may be directed to a computer-implemented method performed by a server for controlling access to a second resource limited by a second access system distinct from a first access system. The method comprises: obtaining, from a reader that reads a token from a user authenticator, (i) the token and (ii) an associated request to perform an access operation with respect to a second resource distinct from a first resource, the token comprising a first identifier portion usable by a first access system distinct from the second access system, and an extension portion including one or more access descriptors; determining that the request is permitted based on one or more of: (A) permission data retrieved from a validation server, (B) validation of the token, and (C) selection of an access descriptor whose resource identifier identifies the second resource and whose validity data authorizes the access operation; generating, in response to determining that the request is permitted, a digital key associated with the second resource; and transmitting the digital key to a receiver of the second access system, the digital key being configured to cause the second access system to perform the access operation with respect to the second resource.

### BRIEF DESCRIPTION OF THE DRAWINGS

The foregoing summary, as well as the following detailed description of exemplary embodiments, will be better understood when read in conjunction with the appended drawings. It should be understood, however, that the invention is not limited to the precise arrangements and instrumentalities shown in the following figures:

FIG. 1 is a schematic diagram of an example system for controlling access to an access-controlled resource;

FIG. 2A-2C are schematic diagrams of example token formats;

FIG. 3 is a schematic diagram of an example receiver configured to verify a digital key and to actuate a control circuit of an access system;

FIG. 4 is a schematic diagram of example servers and interfaces illustrating a validation server, a digital key server, and an API boundary between them;

FIGS. 5A and 5B are flow diagrams of example server-mediated access flows including token reading, permission determination, digital key issuance, delivery to a receiver, and actuation, with a return-operation variant;

FIG. 6 is a flow diagram of an example server method for determining permission based on a token and issuing a digitally signed or authenticated key;

FIG. 7 is a flow diagram of an example on-device amendment method in which a server supplies an amendment package, and an application writes an extension portion to a token maintained by a user authenticator;

FIG. 8 is a flow diagram of an example local amendment method in which an amendment package stored on a user device is unlocked and written to a token;

FIG. 9 is a flow diagram of an example on-device revocation method that removes an extension portion from a token while preserving usability of a first identifier portion by a first access system;

FIG. 10 is a schematic diagram of example access descriptors for multiple resources;

FIG. 11 is a schematic diagram of example digital key contents.

### DETAILED DESCRIPTION OF THE INVENTION

The following description of illustrative embodiment(s) is exemplary and not intended to limit the invention. The description is to be read in connection with the accompanying drawings, which are considered part of the written description. The discussion illustrates possible non-limiting combinations of features that may exist alone or in other combinations. As used herein, “or” is a logical operator that is true when any operand is true; “based on” means “based at least in part on”; and “each,” when used with a plurality of items, refers to the specifically recited items and need not encompass every item in an entire system.

Ranges are used as shorthand for describing every value within the stated range; any value within a range may be selected as a terminus of that range.

All references cited herein are incorporated by reference in their entireties. In the event of a conflict between a definition in the present disclosure and a cited reference, the present disclosure controls.

For clarity, block diagrams and circuit figures may omit peripheral components understood by those of ordinary skill, such as memory devices and power sources. When components are said to be “coupled” or “operably coupled,” power or signal information may be transferred directly or indirectly between them; a direct, intermediary-free connection is not required.

Features of the present invention may be implemented in software, hardware, firmware, or any combination thereof. Computer programs described herein are not limited to any particular embodiment and may be implemented in an operating system, application, foreground/background process, driver, or any combination. Programs may execute on a single processor or across multiple processors/servers.

As used herein, “processor” includes any CPU, microprocessor, microcontroller, computational, or programmable device/circuit configured to execute computer program instructions. Processors may be embodied in desktop, laptop, notebook, tablet, cellular phone, embedded controllers, receiver modules, or other hardware, and may include ancillary components to form a functional data-processing device (e.g., buses, volatile/non-volatile memory, input/output devices, GUIs, removable storage, and wired/wireless interfaces including Wi-Fi, Bluetooth®, LAN, NFC, and RFID). “Processor” may refer to one or more processors.

Computer-executable instructions (software/code) and data may be programmed into and tangibly embodied in a non-transitory computer-readable medium accessible to and retrievable by a processor, which configures and directs the processor to perform desired functions by executing the encoded instructions. Non-transitory computer-readable media include, without limitation, RAM, ROM, flash memory, and magnetic/optical storage (e.g., hard disks, magnetic tape, CD-ROM, DVD-ROM, optical disk, Blu-ray disk), which may be written to and/or read by a processor operably connected to the medium. A device embodying such instructions may be referred to as a “programmable device,” and multiple programmable devices in mutual communication may form a “programmable system.”

In certain embodiments, the invention is embodied as computer-implemented processes and apparatuses (e.g., processor-based data processing and communication systems). Software or computer program code embodied in a non-transitory computer-readable storage medium, when loaded into and executed by such systems, configures the processors and servers to implement the processes described herein.

As used herein, an “access operation” includes, without limitation, actions such as unlock/dispense/enable, open/close, admit/egress, start/stop, and return/re-secure.

As used herein, a “resource” or “target resource” is the specific access-controlled element addressed by a request or digital key. A resource may be (i) a physical asset (e.g., a particular lock, enclosure, compartment, vending position, turnstile/gate, defined area, device dock, or vehicle/docking bay), or (ii) a logical function of such an asset (e.g., enable/disable, dispense, return/re-secure). Each target resource may be identified by a resource identifier, which may be a simple value or a structured value (for example, a lock ID, compartment ID, receiver ID, system/area ID, or a namespace/tenant-scoped identifier) and may also include or reference labels used to associate applicable authorization or program information, such as capability classes, configuration profiles, awards/promotions identifiers, loyalty-tier or program identifiers, usage-limit profiles, or context/policy tags (for example, time-of-day band, geography, or device-state class). In various embodiments, access descriptors may encode such information and/or the resource identifier may carry or reference it; constraints (for example, time windows or counts) and semantics may be expressed in the access descriptor regardless of how the resource identifier is formatted.

As used herein, an “access descriptor” is a machine-readable data structure—carried, for example, in an extension portion of a token or otherwise transmitted, stored, or presented by any suitable medium—that defines capability-scoped authorization and/or information associated with one or more resources and/or operations, together with any applicable conditions or constraints. An access descriptor may, without limitation, identify a resource (or class/namespace of resources) and/or an operation (or class of operations); express permissions, entitlements, settings, configuration, awards/promotions, loyalty or program information, usage limits, or context flags; and specify constraints such as time windows, counts, location or geography, device or context state, or policy indicators. Descriptors may be encoded or formatted in any manner, may be cryptographically protected or not, may be persistent or ephemeral, may reside with the token or be conveyed separately, and may be evaluated and/or enforced by any system component (including a server, reader, device, or receiver). Descriptors may target a single resource or multiple resources and may be selected by exact match or any suitable matching rule, and may be created, added, modified, replaced, enabled/disabled, or removed using the flows disclosed herein.

It should be appreciated that there are many embodiments of the present invention and that, even with respect to the embodiments included, certain steps may be optional or performed in a different order. Moreover, while certain devices are described as containing specific components, such devices may include fewer, more, or alternative components. Equivalent structures and processes may be substituted without departing from the scope of the present invention.

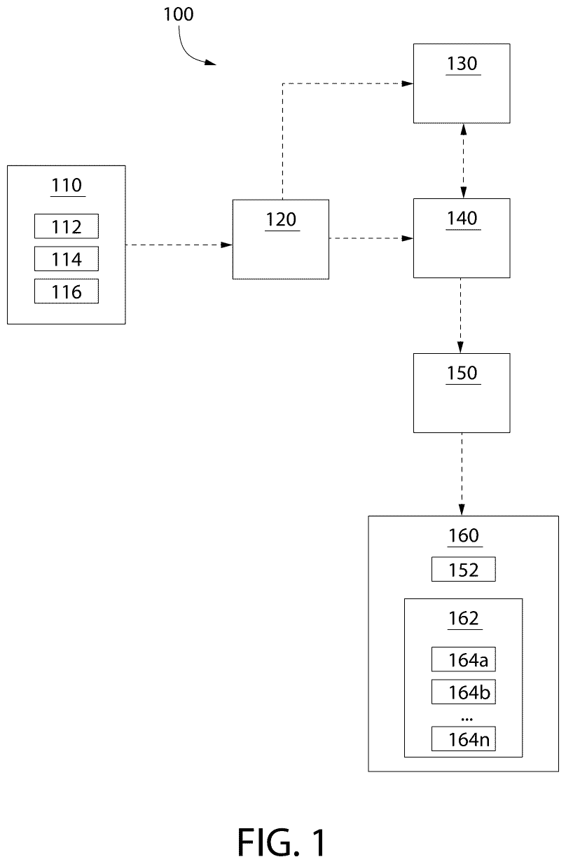

FIG. 1 illustrates an example system 100 for controlling access to an access-controlled system 160. In the illustrated embodiment, a user device 110 carries or manages a user authenticator 112 and executes an application 114. An optional third-party application 116 may also execute on the user device 110. A reader 120 receives a token from the user authenticator 112 (e.g., by presentation of the user authenticator 112 via the user device 110) and communicates with a validation server 130 and a digital key server 140. A receiver 150 is operably coupled to a control circuit 152 of the access-controlled system 160, exemplified by a product vending apparatus 162 with one or more locks 164a-164n.

By way of example, U.S. patent application Ser. No. 18/373,312, filed Sep. 27, 2023; U.S. patent application Ser. No. 16/229,652, filed Dec. 21, 2018; and U.S. Provisional Patent Application No. 62/608,683 , filed Dec. 21, 2017 (each relating to “System and Method for Securing, Releasing, and Managing Inventory”), are incorporated by reference herein in their entireties for disclosures relating to locking units, retail inventory workflows, and article access. In the event of any conflict or inconsistency, the present disclosure controls. No admission is made that any such material is prior art.

In the present embodiment, the user authenticator 112 is associated with the user device 110, but it should be understood that the user authenticator may be, by way of example and not limitation, a hotel key card, barcode/QR code ticket, key fob, biometric credential, wallet pass, or credential presented by the application 114. In certain embodiments, the application 114 manages reading/writing of a token maintained by the user authenticator 112. The optional third-party application 116 can participate in provisioning or gating capabilities associated with the user authenticator 112. It should be understood that the third-party application 116 may be one or more third-party applications.

The reader 120 is configured to read the user authenticator 112 using any suitable modality, such as RFID/NFC, barcode/QR scanning, magnetic stripe, or biometric capture. In various embodiments, the reader 120 may be operated and/or controlled independently from the digital key server 140 (e.g., by a venue, retailer, hotel, or other third party). The reader 120 transmits token data acquired from the user authenticator 112 and a request to perform an access operation with respect to a target resource.

The validation server 130 maintains user identifiers for different users and associations between user identifiers and corresponding user authenticators. User identifiers may be alphanumeric strings. The validation server 130 can confirm whether a user associated with a read token has permission to access a particular resource or operation, and can provide permission data to the digital key server 140. In some embodiments, the validation server 130 and the digital key server 140 are operated by different entities and communicate via an API.

The digital key server 140 receives one or more messages indicating that the reader 120 has read a particular user authenticator 112 and that a corresponding access operation has been requested. Based on one or more of: (i) permission data from the validation server 130, (ii) validation of the token, and/or (iii) matching an access descriptor for the target resource, the digital key server 140 generates a digital key associated with the target resource and transmits the digital key to the receiver 150. In certain embodiments, the digital key may exclude user identifiers and financial data.

The receiver 150 is operably coupled to the control circuit 152 of the access-controlled system 160. The receiver 150 is configured to verify authenticity and, where encrypted, decrypt the digital key - optionally without network connectivity—by checking authenticity information contained in the digital key and ensuring that key parameters (e.g., resource identifier and validity interval) are satisfied. Upon successful verification, the receiver 150 may instruct the control circuit 152 to perform the requested access operation (e.g., unlock, open, enable, dispense, or return). In some embodiments, the receiver 150 may not store user identifiers or financial data.

The access-controlled system 160 may take various forms. In the example of FIG. 1, the access-controlled system 160 includes the product vending apparatus 162 with multiple locks 164a-164n, each configured to secure a corresponding product in a locked state and to be altered between locked and unlocked states. As such, the access-controlled system 160 is an access system. In certain embodiments, at least one lock secures multiple products. The receiver 150 may be physically coupled to, embedded within, or otherwise operably connected to the product vending apparatus 162.

In operation, the user presents or causes presentation of the user authenticator 112 to the reader 120. The reader 120 acquires token data from the user authenticator 112 and communicates the token data and the requested operation to the validation server 130 and/or the digital key server 140. The validation server 130 may communicate one or more messages to the digital key server 140 after validation processing. Based on the messages received from the validation server 130, the digital key server 140 may determine whether the request is permitted and, if permitted, issues a digital key targeted to the access-controlled system 160. Alternatively, the digital key server 140 may receive the token data directly from the reader 120, determine whether the request is permitted, and, if permitted, generate and transmit the digital key as described. The receiver 150 may verify the digital key and, upon success, actuates the control circuit 152 to alter the state of the applicable lock 164 (e.g., 164a—target resource) and effect the requested access.

Although FIG. 1 depicts the validation server 130 and the digital key server 140 as distinct components, they may be implemented on separate physical systems, on a common platform under independent control, or in other distributed arrangements. Similarly, communications between components may be wired and/or wireless and may traverse one or more networks. The arrangement shown in FIG. 1 is provided for clarity of explanation and does not limit the scope of the invention.

In some embodiments, the digital key server may receive one or more messages indicating: that a first user authenticator of user authenticators was read by a reader, the first user authenticator is associated with a first user of different users; that the first user is requesting to alter the state of a first lock of locks; and confirmation that the first user associated with the first user authenticator has permission to access a first product of products.

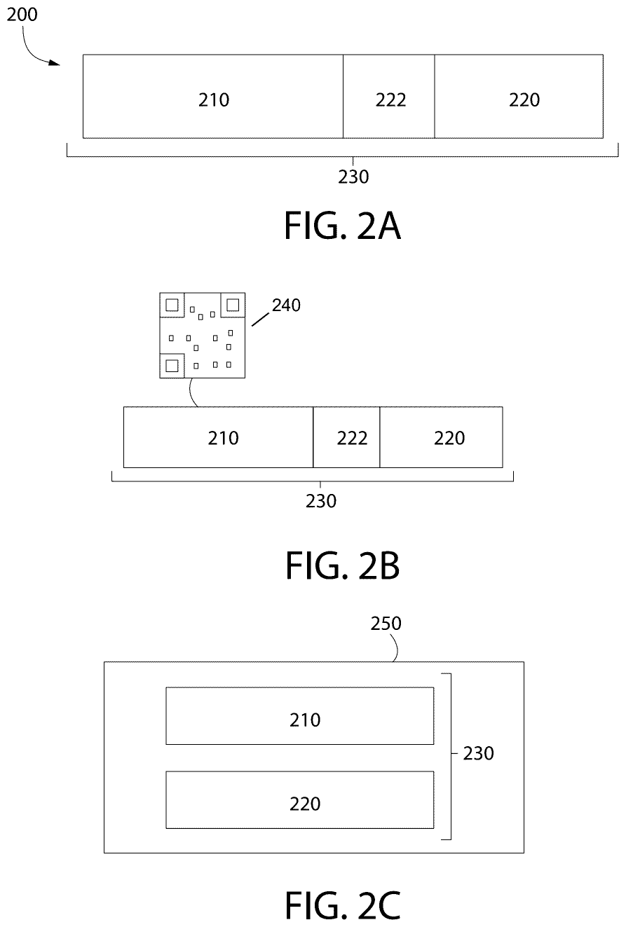

FIG. 2A-2C illustrate example token structures that provide compatibility between first access systems and capability-aware components. In some embodiments, a token 200 carried by the user authenticator 112 may include a first identifier portion 210 that is parsable by readers/validators, while additional access information is conveyed in an extension portion 220 together with a cryptographic authenticator 230. It should be understood that the first identifier portion 210 provides a user with first access rights to a first resource, access to the first resource being limited by a first access system, while the extension portion may provide the user with access rights to a second resource, access to the second resource being limited by a second access system distinct from the first access system.

FIG. 2A shows a token 200 format in which the extension portion 220 is appended as a suffix to the first identifier portion 210 and separated by a delimiter 222. The delimiter 222 is chosen so that legacy parsers either stop at the delimiter 222 or ignore the extension portion 220, thereby continuing to operate without change. A legacy parser is a parser previously associated with the user authenticator comprising the token (e.g., in installed readers, validators, or middleware). The cryptographic authenticator 230 (e.g., a digital signature or a message authentication code) may be generated over at least the first identifier portion 210 and the extension portion 220, binding them together so that tampering with either portion invalidates verification.

The extension portion 220 may encode one or more access descriptors, each descriptor including, for example, a resource identifier for a target lock/compartment/device/area, validity data (e.g., not-before/not-after timestamps and/or a maximum-use count), an operation type (e.g., unlock, dispense, return), and anti-replay data such as a nonce or counter. The extension portion 220 may also include a version indicator and/or a key identifier to support key rotation. In various embodiments, the extension portion 220 and the cryptographic authenticator 230 may exclude user identifiers and financial account data, thereby preserving user privacy while still authorizing capability-scoped access.

For rendered tokens, the delimiter 222 is selected from characters preserved end-to-end by common scanners and middleware and within symbology length budgets (e.g., Code 128, QR Model 2, PDF417). Where middleware truncates or strips delimiters, a fallback may be used: (i) a dual-symbol arrangement in which the first identifier portion 210 occupies a first segment and the extension portion 220 a second; or (ii) presentation via an NFC/NDEF second record (see FIG. 2C). These approaches preserve legacy parsing behavior while reliably transporting the extension. In certain media (e.g., magstripe or linear retail codes with fixed formats), appending in-band may be impractical; in such cases the extension may be conveyed via a QR/PDF417 credential or an NFC/NDEF second record while the legacy medium remains unchanged.

FIG. 2B depicts a QR/barcode rendering 240 of the token 200. The symbol encodes a payload string that is logically ordered as: the first identifier portion 210, a delimiter 222, and the extension portion 220 (optionally followed by the cryptographic authenticator 230). For 2-D symbologies (e.g., QR), leading refers to the prefix of the decoded payload string rather than a physical region of the symbol. In certain embodiments, the extension portion 220 may be encoded using an alphabet compatible with retail scanners (e.g., base-32/base-45 alphanumeric) so that existing imaging or laser scanners capture the full string while legacy software continues to parse only the first identifier portion 210. Where the first identifier portion 210 includes its own check digit (e.g., certain 1-D retail formats), that calculation remains unaffected because the delimiter 222 segregates the appended extension. QR/Data Matrix do not use such symbol-level check digits.

FIG. 2C illustrates an NFC/NDEF variant 250 in which the token is represented by multiple records: a first NDEF record carrying the first identifier portion 210 and a second record carrying the extension portion 220 and the cryptographic authenticator 230. Readers that process only the first record continue to function without modification, while capability-aware applications (e.g., the application 114 on the user device 110 or a compatible reader) read the second record to obtain the extension portion 220. Record types and payloads may follow a Type-Length-Value (TLV) structure to facilitate forward compatibility.

The cryptographic authenticator 230 may be implemented as: (i) a digital signature produced with a private key corresponding to a public key provisioned in downstream verifiers, or (ii) a message authentication code computed with a secret shared between cooperating servers. The appended/delimited structure of FIG. 2A and the structures of FIGS. 2B and 2C ensure that legacy parsing is preserved while enabling access descriptors to be added, rotated, or removed without affecting previously installed systems.

It should be understood that, although FIG. 2A illustrates a suffix placement, the extension portion is not limited to being a suffix and may be provided elsewhere within the token (e.g., as a prefix, as an interleaved or delimited middle segment, or as a separate field or record), provided the first identifier portion remains usable by the original access system and the credential medium preserves end-to-end transport of the extension portion. It should further be understood that the token formats discussed above are merely exemplary and are not limiting; any token format suitable for carrying the necessary data may be implemented.

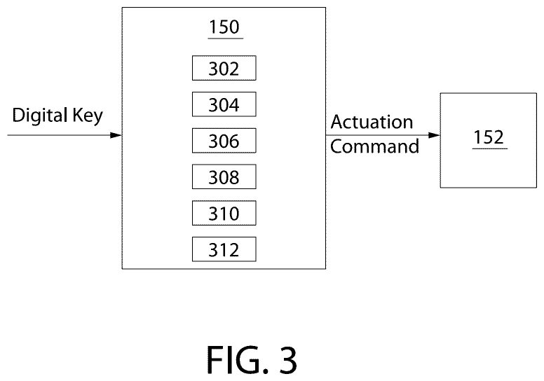

FIG. 3 illustrates an example architecture of the receiver 150 configured to verify a digital key—optionally offline—and to actuate a control circuit 152 of an access-controlled system. In the illustrated embodiment, the receiver 150 includes a crypto engine 302, a trusted timebase 304, a public-key store 306, an anti-replay cache 308, one or more interfaces 310 to the control circuit 152, and optional wired/wireless communications 312.

The receiver 150 supports secure provisioning and rotation of trust anchors/public keys via signed update bundles validated against a manufacturer or platform root of trust stored in memory. Digital keys may carry a key identifier, enabling staged roll-over: a new public key is added, keys referencing either the old or new identifier validate during an overlap period, and the old key is removed after successful migration. Rollback protection prevents loading of outdated trust material.

Trusted timebase 304 may be initialized by a signed time token received during commissioning or maintenance (e.g., a server or reader-originated token signed by an issuer key known to the receiver). Thereafter, bounded drift is enforced; periodic signed re-syncs may be accepted when available. In deployments where time is not continuously maintained, a counter or tick source may constrain acceptance of keys to a limited window, thereby preventing indefinite acceptance of stale keys.

The crypto engine 302 may be configured to verify authenticity and integrity of a received digital key by validating a cryptographic authenticator (e.g., a digital signature or, in certain deployments, a message authentication code). In a signature-based embodiment, the public-key store 306 holds one or more public keys (or a trust anchor/certificate) corresponding to a key used by the digital key server 140. The payload of the digital key can include a key identifier to select among multiple public keys for key rotation. In deployment, the receiver 150 may be provisioned with a shared secret to verify a MAC; however, signature-based verification enables offline validation without provisioning per-receiver secrets.

The receiver 150 may also enforce targeting and validity constraints locally. Using the payload fields of the digital key, the crypto engine 302 may confirm that a lock/resource identifier corresponds to the intended resource (e.g., a specific lock 164) and may evaluate validity data such as not-before and not-after timestamps and/or a maximum-use count. The trusted timebase 304 may supply time to the crypto engine 302 and applies a bounded clock-tolerance window to accommodate skew or drift while preventing indefinite acceptance of expired keys.

To resist replay, the receiver 150 may maintain an anti-replay cache 308 storing, for a bounded interval, nonces, counters, or fingerprints extracted from accepted digital keys. Upon receiving a new digital key, the crypto engine 302 may consult the anti-replay cache 308; if a matching entry is present (or if a counter is non-monotonic), the key may be rejected. Cache entries may expire automatically based on the validity window and/or a configured retention period so that storage remains bounded.

In some embodiments, when all checks succeed—(i) authenticator verification; (ii) resource match; (iii) validity window; and (iv) no replay detected—the receiver 150 issues an actuation command via interfaces 310 to the control circuit 152. Interfaces 310 may include, without limitation, GPIO, relay drivers, UART, I²C, SPI, CAN, RS-485, or other suitable control channels. The control circuit 152 then performs the requested access operation (e.g., unlock, enable, dispense, return) on the access-controlled system.

The optional communications 312 support receipt of digital keys, firmware updates, configuration, or diagnostics via wired (e.g., Ethernet, RS-485) and/or wireless (e.g., BLE, Wi-Fi, Zigbee, sub-GHz) links. Offline validation does not require live connectivity; communications 312 may therefore be disabled or unavailable during normal operation, and the receiver 150 can still validate digitally signed keys.

In certain embodiments, the receiver 150 may employ secure boot, signed firmware updates, locked debug interfaces, and tamper-event detection. Upon detecting a tamper condition, the receiver may (i) enter a deny-all state, (ii) restrict operation to keys with shorter validity windows, and/or (iii) require an administrative re-provisioning step before re-enabling actuation.

If verification fails (authenticator invalid, resource mismatch, expired/over-use, or replay detected), the receiver 150 may deny the request, optionally records a local non-PII fault entry, and may present a status code to upstream systems. Loss of communications does not impair offline validation; if communications are intermittently available, the receiver may opportunistically retrieve configuration/rotation updates without altering the offline verification path.

In various embodiments, the receiver 150 does not store user identifiers or financial data, and the digital keys likewise exclude such data, thereby preserving user privacy at the edge. Minimal audit data (e.g., a hash/fingerprint of the key, resource identifier, and timestamp) may be recorded locally or exported via communications 312 without persisting personally identifiable information. The components shown in FIG. 3 may be implemented discretely or integrated within a microcontroller or secure element; alternative arrangements providing similar functionality fall within the scope of the invention.

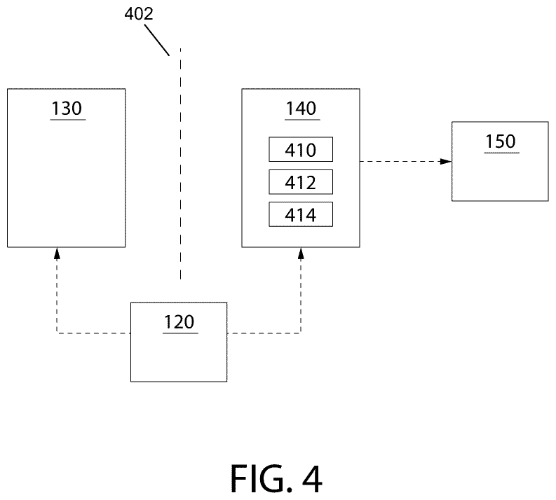

FIG. 4 illustrates a server-side arrangement in which a validation server 130 and a digital key server 140 are implemented as distinct components separated by an API boundary 402. The API boundary 402 represents any programmatic interface (e.g., REST/JSON, gRPC, message bus, webhook) through which the servers exchange permission data and status notifications. This separation supports independent control/operation of the validation server 130 and the digital key server 140 while enabling coordinated decision-making for access requests.

To mitigate lost/stolen authenticators, the digital key server 140 can enforce short validity windows and minimum entropy for anti-replay values. When online, deny-lists of tokens may be enforced at the validator or key server. For edge operation during connectivity outages, receivers may cache a signed, size-bounded deny-list with an expiration; to enable offline comparison without PII exposure, the digital key may include a privacy-preserving token fingerprint (e.g., HMAC over the token or extension), allowing the receiver to block keys derived from listed credentials; if absent or expired, short validity windows continue to limit misuse. In some embodiments, access descriptors and/or digital keys may include a namespace identifier. The receiver 150 may enforce that the namespace in the key matches a local value.

The validation server 130 maintains user identifiers and associations between user identifiers and corresponding user authenticators 112. In response to a read by the reader 120, the validation server 130 can issue a permission message to the digital key server 140 confirming whether a user associated with the read token is permitted to access a target resource, or (alternatively) supply permission data/policies that the digital key server 140 evaluates. In some embodiments, the validation server 130 may provide token-related information (e.g., revocation state, clock guidance) but need not transmit user identifiers to edge devices.

The digital key server 140 may receive access requests and token data from the reader 120 and/or permission data from the validation server 130 via the API boundary 402. Within the digital key server 140, a key issuance module 410 constructs a digital key after a request is determined to be permitted, a signing/encryption module 412 applies cryptographic protections, and an audit log 414 records non-PII audit entries (e.g., key fingerprint, resource identifier, timestamp). The digital key server 140 may operate under a distinct administrative domain from the validation server 130.

The decision that a request is permitted may follow one or more exemplary permission paths. Path (A): the digital key server 140 receives, from the validation server 130, a message indicating that the user associated with the read authenticator has permission to access the target resource. Path (B): the token is validated (e.g., a cryptographic authenticator over the first identifier portion and the extension portion is verified) by the digital key server 140 and/or by the validation server 130, and the digital key server 140 uses the validation result in its permit decision. Path (C): an access descriptor is selected, by the digital key server 140 and/or by the validation server 130, from the token's extension portion whose resource identifier matches the target resource and whose validity data (e.g., not-before/not-after, maximum-use count) permits the requested operation type; absence of a matching descriptor results in denial. In some embodiments the validation server 130 performs (B) and/or (C) and conveys a signed attestation of the result to the digital key server 140; in other embodiments the digital key server 140 performs (B) and/or (C) directly using policies provisioned to it.

When a request is permitted, the key issuance module 410 constructs a digital key payload that may include one or more of: a resource/lock identifier (and optionally a receiver identifier), an operation-type indicator (e.g., unlock, dispense, return), validity data (e.g., not-before/not-after timestamps and/or maximum-use count), an anti-replay value (e.g., nonce or counter), a key identifier to support key rotation, and optional policy flags (e.g., single-use). In privacy-preserving embodiments, the payload excludes user identifiers and financial data—such data may be included in non-privacy preserving embodiments. The signing/encryption module 412 may then (i) digitally sign the payload with a private key corresponding to a public key pre-provisioned in the receiver 150 (enabling offline validation), and/or (ii) encrypt the payload to the receiver using a receiver public key or a shared symmetric key.

The audit log 414 may record a minimal, privacy-preserving entry for each issuance (e.g., a cryptographic fingerprint of the digital key payload or signature, the resource identifier, operation type, and a timestamp), without persisting user identifiers. Audit entries may be linked to a key-rotation schedule by including the key identifier used by the signing/encryption module 412. Retention and export of audit data can be configured without changing the structure or content of issued digital keys.

Although FIG. 4 depicts the validation server 130 and the digital key server 140 as separate systems, they may be co-resident on common infrastructure while remaining logically and administratively independent across the API boundary 402. Communications between the reader 120 and either server, and between the servers themselves, may be synchronous or asynchronous and may traverse wired and/or wireless networks.

This separation allows venues to retain their existing authentication/permissions stack on the validation server 130 while leveraging the digital key server 140 to generate cryptographically protected, receiver-verifiable digital keys.

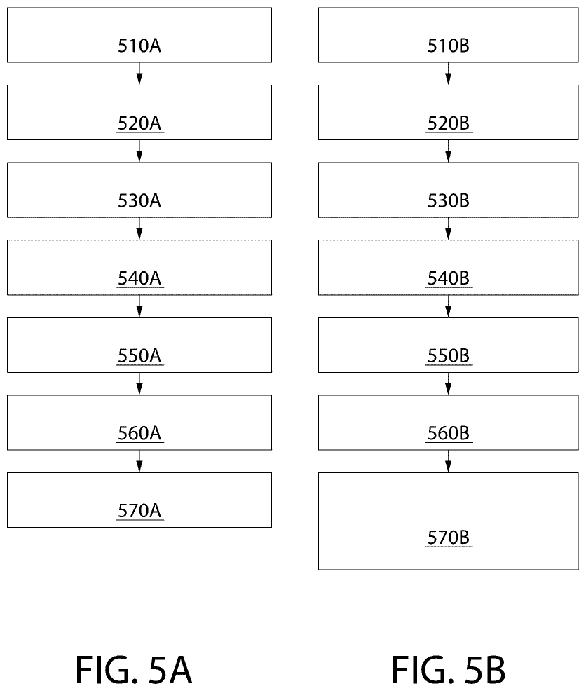

FIGS. 5A and 5B depict diagrams for an exemplary server-mediated access flow for a user/device 110, reader 120, validation server 130, digital key server 140, receiver 150, and lock 164 (via control circuit 152). The flows illustrate exemplary messaging and local checks; message formats and transport protocols are implementation-dependent and may be wired and/or wireless as described herein.

With reference to FIG. 5A, at 510A, a user presents a user authenticator 112 (e.g., hotel key card, QR/Barcode, wallet pass, app token) to the reader 120, which reads a token 200 comprising a first identifier portion 210 and an extension portion 220. At 520A, the reader 120 transmits token data received from the user authenticator 112 and a request for an access operation targeting a particular resource (e.g., lock 164a) to back-end systems.

At 530A, the validation server 130 evaluates the token against permission data and (i) sends a permission message or permission data to the digital key server 140, or, in alternative embodiments, the digital key server 140 may proceed using (ii) token validation and/or (iii) access descriptor matching. At 540A, upon determining that the request is permitted, the key issuance module 410 constructs a digital key payload including, by way of example, a resource/lock identifier, an operation-type indicator (e.g., unlock/dispense), validity data (e.g., not-before/not-after and/or maximum-use count), and anti-replay data (e.g., nonce), while excluding user identifiers and financial data. The signing/encryption module 412 may digitally sign the payload (and optionally encrypts it to the receiver) and the audit log 414 records a non-PII audit entry.

At 550A, the digital key is transmitted to the receiver 150. At 560A, the receiver 150 may verify the key—optionally offline—using a public-key store 306, crypto engine 302, and trusted timebase 304 (checking authenticity, targeted lock identifier, validity window, and anti-replay cache 308). On success, at 570A, an actuation command may be issued over interfaces 310 to the control circuit 152, and the lock 164a transitions from locked to unlocked to perform the requested access. If any check fails, the receiver 150 may deny the request.

FIG. 5B illustrates an exemplary variant return workflow. Blocks 510B-540B mirror those in FIG. 5A, except the operation-type in the access descriptor and the issued key is “return” (i.e., re-secure). At 550B, the receiver 150 obtains the digital key and, at 560B, the receiver 150 validates it. The operation-type is enforced locally: if the key authorizes “return,” the receiver 150, at 570B, actuates the control circuit 152 to enable a return action (e.g., temporarily unlock to accept placement of an item, then re-lock, or enable a “return chute” or “return mode” of the access-controlled system 160). A key marked “return” will not authorize a dispense or take-away unlock operation; the receiver 150 denies such requests even if other parameters match. Optionally, the receiver 150 may record a local non-PII audit entry indicating successful return actuation.

For “return/re-secure” operations, the control circuit 152 may require confirmation signals (e.g., door-closed/latched sensors, presence detection, or motor current thresholds) before re-locking and recording a successful return event. Absent confirmation within a timeout, the receiver 150 may re-lock in a safe state and log a failed return attempt, without authorizing a dispense operation under a “return-only”key.

Representative transport options for delivering a digitally protected key to the receiver 150 without changing the receiver's verification logic may include wireless, wired, and bridged paths. Wireless path: The digital key server 140 transmits the signed (and optionally encrypted) digital key to the receiver 150 via a wireless link (e.g., BLE, Wi-Fi, sub-GHz). Wired path: The digital key server 140 sends the digital key over a wired network (e.g., Ethernet, RS-485, CAN) to the receiver 150. Bridged path: The digital key is routed through the reader 120 and/or the user device 110 acting as a relay (e.g., reader to receiver over a local fieldbus; device-to-receiver via BLE/NFC). In all of these cases, the receiver 150 may perform the same offline validation using its local trust anchors and timebase and then actuates the control circuit 152.

The sequences in FIGS. 5A and 5B exemplify a server-mediated flow that supports reading a token, determining permission via one or more paths, issuing a digital key bound to a target resource and operation type, and receiver-side validation and actuation. Operation-type encoding and enforcement (e.g., unlock/dispense vs. return) are shown by way of example and can be extended to other actions (enable/disable, open/close, grant/deny). Transport choices are interchangeable and may be combined within the same deployment without departing from the scope of the invention.

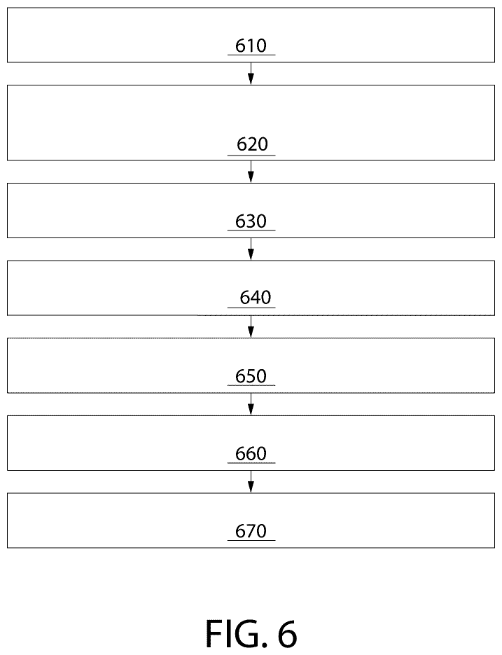

FIG. 6 depicts a server-side flowchart for issuing digitally protected keys based on a token read from a user authenticator 112. As used in FIG. 6, “server” refers to the digital key server 140 unless expressly stated otherwise. The exemplary flow operates in concert with the validation server 130, receiver 150, and access-controlled system 160 discussed above; in some embodiments the validation server 130 performs certain checks and conveys a signed attestation that the digital key server 140 consumes.

With reference to FIG. 6, at 610, the digital key server 140 receives—directly from the reader 120 or indirectly from the validation server 130—a token 200 or a token-derived, validator-signed attestation, together with a request to perform an access operation with respect to a target resource (e.g., a specific lock 164a). The token may comprise a first identifier portion 210 associated with a first resource and, where present, an extension portion 220 associated with one or more additional resources. At 620, the digital key server 140 determines that the request is permitted via one or more permission paths: (i) receipt of a permission message/attestation from the validation server 130 (Path A); (ii) validation by the digital key server 140 of the token or attestation (Path B); and/or (iii) selection by the digital key server 140 of an access descriptor in the extension portion 220 whose resource identifier matches the target resource and whose validity data authorizes the requested operation type (Path C). If not permitted, the request may be denied.

At 630, upon a permit determination, a key issuance module 410 of the digital key server 140 constructs a digital key payload including one or more of: a resource/lock identifier (and optionally a receiver identifier), an operation-type indicator (e.g., unlock/dispense/return), validity data (e.g., not-before/not-after and/or maximum-use count), and optionally an anti-replay value, while excluding user identifiers and financial data. At 640, a signing/encryption module 412 applies cryptographic protections (e.g., digitally signs the payload with a private key corresponding to a public key pre-provisioned in the receiver 150, and optionally encrypts the payload to the receiver). A non-PII audit log 414 entry may be recorded.

At 650, the digital key server 140 transmits the digital key to the receiver 150 over a wired and/or wireless transport. As contextual follow-on (outside the server's execution), at 660, the receiver 150 verifies the digital key (optionally offline), and, upon success, at 670, the control circuit 152 actuates to perform the requested operation. This baseline flow may thus correspond to: receive→determine→generate→transmit→actuate.

In deployments where the token includes a cryptographic authenticator 230, that authenticator is verified prior to the permit decision. For example, the digital key server 140 may verify a message authentication code (MAC) computed over at least the first identifier portion 210 and the extension portion 220 using a secret shared with the validation server 130, or verify a digital signature using a public key corresponding to a token-signing private key. In alternative embodiments, the validation server 130 may perform this verification and return a signed attestation that the digital key server 140 relies upon. Failure to verify may result in denial without issuing a digital key. Where the extension portion 220 carries anti-replay data (e.g., a nonce) as part of an access descriptor, the digital key server 140 can also bind the issued digital key to that nonce (e.g., by echoing it in the key payload) so that the receiver 150 can detect replays.

When the token carries multiple access descriptors for different resources, the digital key server 140 may select the access descriptor whose resource identifier matches the target resource and denies the request if no match is present. In some embodiments the validation server 130 may perform this selection and convey the result to the digital key server 140 (e.g., as a signed access attestation).

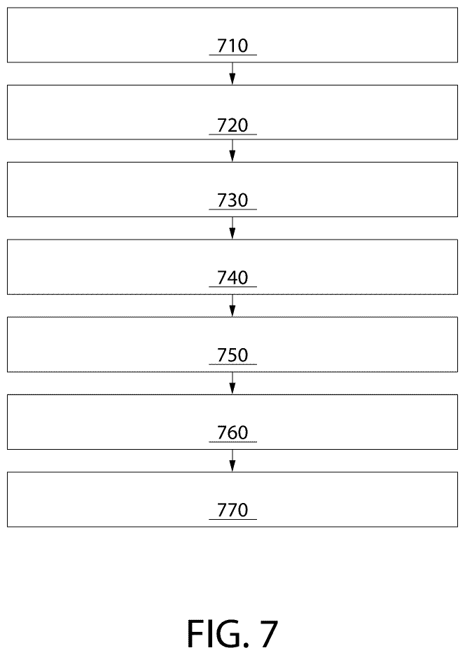

FIG. 7 illustrates a server-assisted, on-device amendment flow in which an application on the user device 110 updates a token on a user authenticator 112 with capability information supplied by a back-end server. As used in FIG. 7, “server” refers to the digital key server 140 unless expressly stated otherwise. In some embodiments, the validation server 130 generates and/or signs amendment material and the digital key server 140 relays it to the device or validates entitlements prior to release.

With reference to FIG. 7, at 710, an application 114 reads from the user authenticator 112, the token's first identifier portion 210 (and any existing extension, if present). The user authenticator 112 can be, for example, a rewritable NFC credential (NDEF), a software credential rendered as a QR/barcode on the device display, or a wallet pass, each parsable by legacy readers.

At 720, the application 114 transmits to the digital key server 140 (optionally in concert with the validation server 130) data indicative of the first identifier portion 210 and a request to modify privileges for a target resource. In response, at 730, an amendment package is received comprising: (i) an extension portion 220 with one or more access descriptors (e.g., resource identifier, operation-type, validity data, and anti-replay nonce/counter), and (ii) a cryptographic authenticator 230 generated over at least the first identifier portion 210 and the extension portion 220. In alternative embodiments, the validation server 130 issues or produces and signs the amendment package (e.g., with a validator signature or MAC), and the digital key server 140 handles delivery; in either case, the resulting token can later be validated by the server(s) when read. The amendment package may also include a key identifier (for key rotation), a version field, and a fingerprint of the token (e.g., a hash of the legacy portion) so that the write can be bound to the correct authenticator. For privacy, the extension portion 220 and authenticator 230 may exclude user identifiers and financial data. The server may encrypt the amendment package to the application 114 and/or require proof-of-possession before release.

In some embodiments, the digital key server 140 (or, in the alternative, the validation server 130) causes the write by returning the amendment package together with a write instruction/policy, and the application 114 acts as an agent to perform the update on the user authenticator 112. In other embodiments, a third-party application 116 integrated on the user device 110 mediates the request (e.g., checks membership or entitlement) and, upon authorization, retrieves and forwards the amendment package to the application 114 for writing.

At 740, the application 114 writes the extension portion 220 and the cryptographic authenticator 230 to the token on the user authenticator 112 while preserving the first identifier portion 210. After writing, the application 114 can read the token to confirm that: (i) the delimiter 222 is correctly placed; (ii) the extension portion 220 matches the target resource; and (iii) the cryptographic authenticator 230 verifies locally (when verification keys are provisioned to the device) or defers verification to downstream components.

At 750, the user can present the amended token to a reader 120 to request an access operation with respect to the access-controlled system 160 (e.g., a lock 164 of a product vending apparatus 162). The reader 120 forwards the request and token data to the back end; the digital key server 140 determines permission and issues a digital key. At 760, the receiver 150 may obtain the digital key and perform verification. Upon success, at 770, the control circuit 152 actuates to perform the requested operation type encoded in the key, while denying operations not authorized by that type.

Throughout, neither the digital key nor the receiver stores user identifiers or financial data, and any audit produced is non-PII. The server-assisted amendment flow of FIG. 7 allows permissions/restrictions to be added or rotated on the user authenticator 112 without modifying legacy parsers and without exposing sensitive user data to readers or receivers. The same pattern supports removal of prior extensions by supplying an amendment package that deletes or supersedes an existing extension portion 220, thereby revoking modified access while leaving the first identifier portion 210 intact.

As such, it should be appreciated that the data received via the amendment package is data indicative of a user's altered access rights with respect to a particular resource distinct from a resource associated with the first identifier portion of the token. Thus, it is considered that, upon presentation of the user authenticator 112 to an access system associated with the data, the user authenticator 112 may provide the user access rights to access a resource in accordance with the altered access rights; and wherein, after the writing of the data to the user authenticator, the user authenticator continues to provide the user with the access rights to the resource associated with the first identifier portion such that the resource associated with the first identifier portion can be considered a first resource and the resource associated with the extension portion can be considered a second resource.

Additionally, although FIG. 7 is described with reference to an “application 114” performing the write, “application” is used broadly. Any software or firmware capable of effecting the write or causing it—including an OS service, wallet/pass app or applet, trusted execution environment (TEE) or secure-element applet, driver, library, background service, kiosk/reader middleware or agent, microcontroller firmware, or a scriptable service—may perform the write.

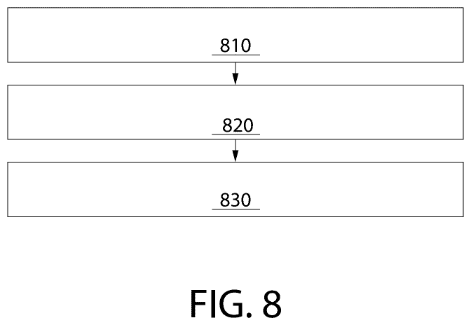

FIG. 8 illustrates an on-device amendment flow in which a user device 110 updates a token on a user authenticator 112 without contacting a remote server at amendment time. The flow corresponds to an amendment package being pre-positioned on the device (e.g., in a trusted execution environment), local predetermined conditions are evaluated, and—if satisfied—the device unlocks the package, writes an extension portion 220 and its cryptographic authenticator 230 to the token, and later presents the amended token to a reader 120.

With reference to FIG. 8, at 810, an amendment package is stored on the user device 110. The package contains, for a target resource, (i) the extension portion 220 (with one or more access descriptors, such as resource identifier, operation-type, validity data, and optional anti-replay value), and (ii) a cryptographic authenticator 230 generated over at least the first identifier portion 210 and the extension portion 220.

To bind the package to the correct credential, the package may also carry a fingerprint (e.g., hash) of the first identifier portion 210. The package is locked, for example, encrypted to device or app-specific keys protected by a secure element, and is inaccessible until predetermined conditions are met. The conditions may include one or more of: a time window (not-before/not-after), geofence or proximity-beacon presence, biometric verification, device-integrity attestation, user consent, or other locally checkable signals. No network connectivity is required to evaluate these conditions.

In addition to device and context-based checks, the predetermined conditions may include application-defined criteria that, when satisfied, increase access privileges. Examples include meeting predefined goals (e.g., a purchase-count or spend threshold for designated items), acquiring/holding an active membership/subscription, possession of a valid promotion/coupon, successful event check-in, completion of training or age-gating, or other feasible criteria. These criteria can be evaluated offline by validating verifiable entitlements (e.g., issuer-signed receipt tokens or membership credentials) against public keys embedded in the evaluating application, thereby preserving privacy and supporting offline operation while avoiding exposure of user identifiers or financial data.

When the application 114 determines that the predetermined conditions are satisfied, it may unlock or receive the amendment package, at 820, to obtain the extension portion 220 and the cryptographic authenticator 230. Before writing, the application 114 may verify that the fingerprint in the package matches the credential's current first identifier portion 210; if it does not, the write may be aborted.

At 830, the application 114 writes the extension portion 220 and authenticator 230 to the token on the user authenticator 112 while preserving the first identifier portion 210. If the package includes access descriptors for multiple resources, the application selects the access descriptor whose resource identifier matches the requested target resource and declines to amend when no match is present. The application 114 may then read the token to confirm correct formatting.

In some embodiments, a third-party application 116 on the user device 110 stores the amendment package and releases it only when its own conditions are satisfied (e.g., membership validity, venue policy, loyalty thresholds). The third-party application 116 can maintain an entitlement-token store (e.g., signed receipt tokens, signed membership credentials) and, upon validating the requisite entitlements offline, provides the amendment package to the application 114 via an inter-app handoff or secure OS broker.

The validity data in the extension portion 220 may specify a single-use or maximum-use count. The application 114 can enforce these semantics by: (i) monitoring presentation events (e.g., app-controlled QR display or NFC write action) and, after first use or upon reaching the maximum count, deleting the extension portion 220 and authenticator 230 from the token; and/or (ii) scheduling automatic removal when a not-after time is reached. Removal preserves the first identifier portion 210 so legacy parsing continues to function. Furthermore, the extension portion 220 and cryptographic authenticator 230 may exclude user identifiers and financial data. If the application 114 records an audit, it may store non-PII elements locally for later reconciliation.

Additionally, as a loyalty threshold example, each qualifying purchase can generate a signed receipt token that encodes at least a product class identifier, venue identifier, and validity data, but omits PII. The third-party application 116 (or application 114) may validate N distinct receipt signatures within a defined time window and, upon success, release or unlock the amendment package so the extension portion 220 can be written. After the write, the application 116 may delete used receipt tokens and/or mark the package as consumed.

The offline local-unlock flow of FIG. 8 enables capabilities to be added, rotated, or later removed on the user authenticator 112 using only on-device checks, including app-level program conditions, maintaining compatibility with legacy parsers and minimizing edge exposure of sensitive data, while producing amended tokens that downstream components (reader, servers, and receiver) can use within the broader access workflow described herein. To prevent transfer or double-spend across devices during offline evaluation, each receipt or membership credential may embed a device public key (or authenticator fingerprint) and a unique nonce within the issuer-signed payload; the evaluating application rejects receipts not bound to the device or previously consumed.

In some embodiments, the write operation at 740 (and, in the FIG. 8 flow, at 830) rewrites, in its entirety, the token; in these embodiments the rewritten token comprises the first identifier portion 210 and the extension portion 220 (and, where used, the delimiter 222 and cryptographic authenticator 230), with the content of the first identifier portion 210 preserved so that the original access system continues to operate without modification.

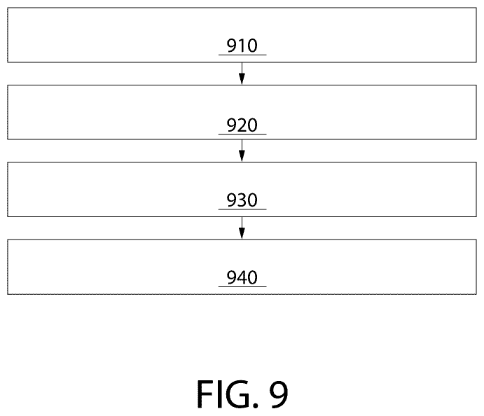

FIG. 9 illustrates an on-device revocation/removal flow in which a user device 110 removes modified access from a token on a user authenticator 112 while preserving particular compatibilities.

With reference to FIG. 9, a revocation monitor executing within the application 114 (and/or a third-party application 116) continuously or periodically evaluates revocation conditions at 910. Exemplary representative conditions include: (i) expiration of validity data associated with the extension portion 220 (e.g., not-after time or maximum-use count reached); (ii) receipt, from the third-party application 116, of a local instruction to revoke (e.g., membership ended, venue policy change, loyalty benefit consumed); (iii) detection of device-integrity loss (e.g., failed attestation, jailbreak/root detection, trusted timebase failure); and (iv) a user-initiated command (e.g., “remove elevated access”). These conditions may be evaluated offline using locally available signals and, where applicable, verifiable entitlements stored on the device, thereby avoiding exposure of user identifiers or financial data to readers or receivers.

Upon determining that one or more revocation conditions are satisfied, the application 114, at 920, quiesces token updates by acquiring a local write lock and (optionally) presenting a user confirmation via a user interface of a user device, for example. To ensure robustness against power loss, the application 114 may use transactional/journaled writes and maintain an ephemeral backup of the token's current state until revocation completes.

The application 114, at 930, then amends the token on the user authenticator 112 by removing the extension portion 220 and associated cryptographic authenticator 230 while retaining the first identifier portion 210 intact. Where revocation occurs as part of amending to new privileges, the application may first remove any prior extension/authenticator and then subsequently write the new extension/authenticator.

After the write, the application 114, at 940, may read the token to verify that the extension is absent and that the first identifier portion 210 parses correctly. If verification fails, the application can roll back using its ephemeral backup and retry. On success, any temporary backup may be deleted. Consistent with privacy goals, no user identifiers or financial account data are written to the token during revocation if desired. Following removal, presentation of the token to a reader 120 results in legacy behavior; augmented capabilities are no longer available and therefore no digital key will be issued for augmented operations. The application 114 may optionally record a non-PII audit entry in local storage for reconciliation. Re-application of augmented access, if later permitted, proceeds via the server-assisted flow (FIG. 7) or the offline local-unlock flow (FIG. 8).

The revocation/removal flow of FIG. 9 ensures that elevated privileges can be promptly withdrawn in response to expiry, program rules (third-party instruction), security posture changes (loss of integrity), or user choice, while preserving legacy parsing and offline operation.

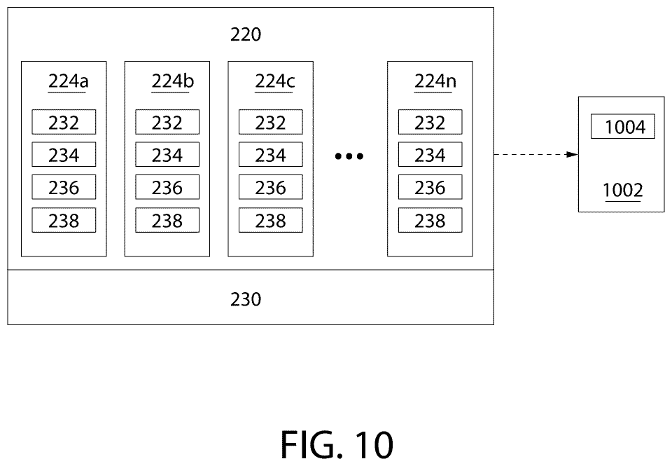

FIG. 10 illustrates an exemplary multi-resource access model and selection/denial logic used when a single extension portion 220 carries permissions for more than one resource. To avoid confusion with the delimiter 222, the extension's individual access descriptors are identified as 224a-224n. Each access descriptor includes at least a resource identifier 232, an operation-type 234 (e.g., unlock/dispense or return/re-secure), and validity data 236 (e.g., not-before/not-after, maximum-use count). Optionally, an access descriptor may also include an anti-replay value 238 (nonce/counter) bound by the cryptographic authenticator 230 described earlier. The extension portion 220 and its access descriptors 224a-224n may exclude user identifiers and financial data, consistent with privacy-preserving embodiments.

In a rendered QR/barcode token, the extension portion 220 may encode access descriptors 224a-224n as delimited key-value sets following the first identifier portion (suffix model) with the delimiter 222 separating legacy and extension segments. In an NFC/NDEF token, the extension portion 220 may reside in a second record that contains a tagged representation of the access descriptors 224a-224n (see FIG. 2C). In both cases, the cryptographic authenticator 230 covers at least the first identifier portion 210 and the entire extension portion 220, including every access descriptor (224a-224n).

A matching logic 1002 of the digital key server 140 and/or the validation server 130 may receive a target resource identifier (e.g., derived from the receiver 150/control circuit 152 lock identity, from a compartment identifier of the access-controlled system 160, or from context in a reader/server request) and selects the access descriptor among 224a-224n whose resource identifier 232 equals (or matches per a defined rule set) the target resource identifier 1004. This selection can occur in the digital key server 140 and/or at the validation server and/or be reinforced at the receiver 150 during offline key validation. If no matching descriptor is present, the request is denied (no digital key issued and/or no actuation), while legacy parsing remains unaffected.

When a matching descriptor is found, its operation-type 234 further constrains the action that may be performed. The operation type may also include relevant information associated with an access descriptor. For example, a descriptor whose operation-type 234 indicates “return/re-secure” authorizes only a return workflow and will not authorize a purchase/dispense operation. The digital key issued by the server 140 may encode the allowed operation-type 234, and the receiver 150 enforces that the requested access operation matches the encoded type.

The validity data 236 and optional anti-replay value 238 are evaluated as part of selection and enforcement. The receiver 150 may verify that validity constraints are satisfied and that replay has not occurred, before actuating the control circuit 152.

In one example, the extension portion 220 includes access descriptors 224a for “Lock A/Dispense,” 224b for “Lock A/Return,” and 224c for “Locker-Bank-B/Compartment-7/Return. ” A request targeting “Lock A” to return a product matches 224b and is permitted; a request to dispense from “Locker-Bank-B/Compartment-7” does not match any descriptor and is denied. Denial can occur at the digital key server 140 (no key issued) and/or at the receiver 150 (key rejected or operation mismatch), and any optional audit log 414 may record only non-PII artifacts.

Additional exemplary access-controlled systems that serve as target resources for the techniques disclosed herein follow.

A product vending apparatus secures individual items with locks (e.g., latches, solenoids, motorized releases). A receiver may be integrated inside the fixture or mounted externally and coupled (e.g., by wiring, bus, or short-range wireless) to a control circuit that actuates the locks.

An enclosure (e.g., cabinet, drawer, case) includes a door secured by a lock (e.g., electronic strike or electromagnetic lock). A control circuit energizes/releases the mechanism upon acceptance of a digital key by a receiver.

A turnstile gate controls entry to a defined access area (e.g., a ski slope, lift line, arena section). The gate includes a barrier (e.g., rotor or arm) driven by an actuator under a control circuit. A receiver mounted within the gate housing validates a digital key and, if permitted, signals the control circuit to release the barrier. Access descriptors may encode operation-type (admit/egress), time windows (e.g., day-pass vs. single-ride), and replay protection, without exposing user identifiers at the gate.

A vehicle (e.g., car, scooter, bicycle with smart lock, or other conveyance) is treated as an access-controlled resource. A receiver may be embedded in a vehicle controller or mounted within a dock/charging stand. A control circuit drives a vehicle lock or immobilizer (e.g., door latch, steering lock, motor enable line). A validated digital key can authorize operations such as unlock, start/enable, or return/re-secure (for shared mobility). Resource identifiers in access descriptors may address a specific vehicle or docking bay.

In exemplars, “operably coupled” may include direct wiring, backplane/bus connections, driver/relay interfaces, or wireless links that allow the receiver to deliver control signals to the control circuit. The receiver may be internal to the resource, integrated with a lock, or external on the chassis/frame. These placements do not alter the flows for key issuance, offline validation, or actuation.

Existing fixtures, gates, and vehicles can be retrofitted by adding an external receiver and an interface to the incumbent actuator. A single receiver may command multiple locks subject to per-resource operation-type restrictions encoded in the digital key. The variety of target resources demonstrates that the disclosed systems and methods generalize beyond merchandise fixtures to area access (turnstiles) and vehicle access, while remaining consistent with the system architecture, privacy posture, and server/reader independence described herein.

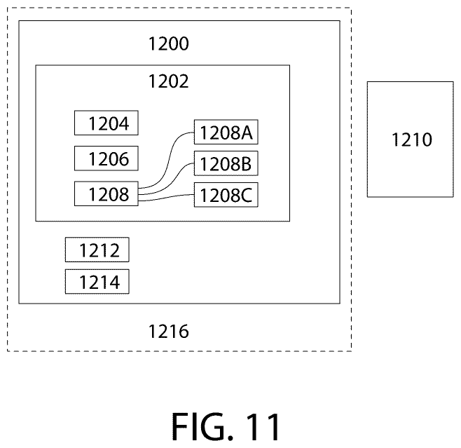

FIG. 11 illustrates an example digital key 1200 and a corresponding privacy posture. The digital key 1200 is generated by the digital key server 140 and consumed by a receiver 150 to authorize a specific access operation on a target resource (e.g., a lock 164 of an access-controlled system 160). In some embodiments the key contains only what the receiver needs to validate and enforce the request.

In the example of FIG. 11, the key 1200 carries a payload 1202 comprising: a resource identifier field 1204 (e.g., a lock ID, compartment ID, receiver ID, or system ID); an operation-type field 1206 (e.g., dispense/unlock vs. return/re-secure); validity claims 1208 including at least a not-before (NBF) timestamp 1208a, a not-after (NAF) timestamp 1208b, and optionally a maximum-use count 1208c; and a nonce/token-binding field 1212 (e.g., a unique value or a fingerprint echo of the access descriptor) to provide anti-replay and to bind the key to the originating token. The payload 1202 is protected by a digital signature 1214 produced with the server's private key corresponding to a public key pre-provisioned in the receiver. In some embodiments the signed payload is further wrapped in an encryption envelope 1216 (e.g., to the receiver's public key or a shared symmetric key) to provide confidentiality over the transport path.

During validation, the receiver (i) verifies the signature 1214 using a public key from its public key store; (ii) confirms the resource identifier 1204 matches the addressed resource (e.g., its own lock ID or compartment); (iii) checks the validity claims 1208 against its trusted timebase and, if present, decrements/enforces the maximum-use count 1208c; and (iv) evaluates the nonce/token-binding 1212 against an anti-replay cache. If all checks succeed, the receiver may instruct the control circuit to actuate, thereby enforcing operation-type 1206 constraints (e.g., a “return” key cannot perform a “dispense” operation). Because the receiver processes only these fields, no user identifiers or financial data need be present in the key 1200 or stored at the edge. Nonetheless, user identifiers and financial data may be incorporated if desired.

FIG. 11 also depicts an optional audit entry 1210 that a server or administrative system may create contemporaneously with key issuance or validation. The entry 1210 may include only non-PII artifacts, such as a fingerprint of the key payload (e.g., a hash), the resource identifier 1204, a timestamp, and optionally an operation-type indication. Persisting this record supports diagnostics and reconciliation without storing user identity or account information.

The digital key format of FIG. 11 is illustrative. Fields may be encoded as text, TLV, CBOR/JSON, or other serializations; the semantics - resource binding, validity constraints, operation restriction, anti-replay, and cryptographic protection - remain as described to support offline verification and are non-limiting.

On the issuance side, the digital key server may reject reuse of extension-borne nonces/counters within a bounded window and may embed a distinct server-generated nonce in the key payload to create a composite binding. This dual binding allows the receiver to detect replays even when the originating token's extension is static over a short period.

For offline enforcement of maximum-use counts, the receiver may maintain a bounded, tamper-resistant usage record (e.g., a secure counter or a protected cache keyed by the fingerprint of field 1212 and the resource identifier 1204). Upon successful validation, the receiver decrements or records consumption and rejects further presentations that would exceed the allowed count, independent of network connectivity. In one embodiment, the bounded usage record is maintained using a non-volatile monotonic counter or append-only log in protected storage to survive power loss and resist rollback.

The following non-limiting scenarios illustrate representative deployments consistent with the foregoing description. Terms such as user authenticator, token, first identifier portion, extension portion, delimiter, cryptographic authenticator, reader, validation server, digital key server, receiver, control circuit, and digital key are used as previously described.

A passenger's airline boarding credential serves as the user authenticator. The token on the credential includes a first identifier portion that remains usable by the airline's access system for boarding. Using a server-assisted amendment flow, an application on the user's device receives an amendment package containing an extension portion with one or more access descriptors for a duty-free enclosure and a cryptographic authenticator generated over at least the first identifier portion and the extension portion. The extension portion is appended as a suffix separated by a delimiter, or stored in a second NFC/NDEF record, so that legacy boarding parsers continue to operate without modification.

Each access descriptor identifies target resources within the duty-free store, includes validity data aligned to the travel window, and includes an anti-replay value. At the store, a reader acquires the token and forwards token data and the requested operation to back-end systems. Permission is determined based on validator permission data, token validation, and/or selection of a matching access descriptor. When permitted, a digitally protected key is issued that includes a resource identifier, an operation-type indicating dispense or unlock, a validity interval, and an anti-replay value. The key is digitally signed and optionally encrypted and delivered to a receiver coupled to the enclosure's control circuit.

The receiver verifies the signature using pre-provisioned trust anchors, enforces the validity window using a trusted timebase, checks the targeted resource, and rejects re-use using an anti-replay cache. Upon success, it actuates the control circuit to perform the authorized operation. The digital key excludes user identifiers and financial account data, and the receiver need not store such data. After a single use or upon expiration, the application may remove the extension portion and its authenticator while preserving the first identifier portion for boarding.

A skier's general resort pass is the user authenticator and remains usable for standard lifts via the first identifier portion. A locally stored amendment package is pre-positioned on the user's device and remains locked until predetermined conditions are satisfied. The conditions may include validation of a threshold number of issuer-signed receipt tokens corresponding to completed runs within a pre-defined time window.

When the conditions are met, the device unlocks the amendment package and writes the extension portion and its cryptographic authenticator to the token, preserving the first identifier portion. The extension portion carries an access descriptor identifying a turnstile for an additional slope area, an operation-type of admit or egress, validity data such as a day-pass window, and an anti-replay value. At the turnstile, the reader forwards the token and request. Permission is determined based on validator data, token validation, and/or descriptor selection. A digitally signed key restricted to admit or egress for the addressed gate and validity interval is issued and delivered to the receiver within the gate.

The receiver validates the key using its public keys, enforces the validity interval using a trusted timebase, rejects replay using an anti-replay cache, and actuates the barrier upon success. If a maximum-use count applies, the receiver maintains a bounded usage record to enforce the count offline. After uses are consumed or the validity window expires, the application removes the extension portion and authenticator while leaving the first identifier portion intact for general resort access. No user identifiers or financial account data are exposed at the gate; any optional audit records only non-PII artifacts.

A hotel issues a room key that serves as the user authenticator. The first identifier portion remains usable by the hotel's door-lock system. Using a server-assisted amendment flow executed by a hotel or store application on the user device, or by a kiosk agent, an amendment package is obtained and used to write an extension portion and its cryptographic authenticator to the same credential while preserving the first identifier portion.

The extension portion contains one or more access descriptors for a retail enclosure within the hotel. Each descriptor includes a resource identifier, an operation-type (for example, dispense or unlock; in a variant, return or re-secure), validity data defining a limited shopping window, and an anti-replay value. At the store, a reader obtains the token and submits the request. Permission is determined based on validator permission data, token validation, and/or matching of the descriptor to the targeted resource and operation. A digitally signed key targeted to the enclosure and restricted to the encoded operation is issued and sent to the receiver coupled to the control circuit.

The receiver validates the key and, upon success, instructs the control circuit to unlock the compartment to complete the authorized action. The key excludes user identifiers and financial account data, and the receiver stores neither. After a single use or upon expiration, the application removes the extension portion and its authenticator; the room key remains functional for door access.

A city transit card serves as the user authenticator. Its token includes a first identifier portion usable by the transit fare-collection system. Using a server-assisted amendment flow, or a flow mediated by a third-party application that gates membership or subscription, an amendment package is obtained and used to write an extension portion and its cryptographic authenticator to the same credential while preserving the first identifier portion. The extension portion may be appended so that legacy fare readers continue to parse only the first identifier portion.

The extension portion encodes one or more access descriptors for shared micromobility resources, such as a specific dock or vehicle. Each descriptor includes a resource identifier, an operation-type (for example, start or enable; in a variant, return or re-secure), validity data (for example, a not-before and not-after window and optionally a maximum-use count), and an anti-replay value. At a dock or vehicle, a reader acquires the token and submits the request. Permission is determined based on validator permission data, token validation, and/or selection of a matching descriptor for the targeted resource and operation.

When permitted, a digitally protected key is generated. The key is digitally signed and optionally encrypted. Where the dock or vehicle lacks network connectivity, the key is delivered over a bridged path via the reader or the user's device (for example, over a short-range wireless link) without altering the receiver's offline verification logic.

The receiver validates the key offline, and then instructs a control circuit to enable the vehicle or release a lock. The receiver may also enforce a namespace value encoded in the key and may apply a signed, size-bounded deny-list of privacy-preserving token fingerprints; if a deny-list is absent or expired, short validity windows may limit misuse. After a ride completes, after a single use, or upon expiration of validity, the application removes the extension portion and its authenticator while the first identifier portion remains usable for transit access.

At a live sporting event, a fan's event credential (for example, a ticket or wallet pass) serves as the user authenticator. The credential's token retains a first identifier portion usable by the venue's entry system. Through a third-party team application, the fan signs in and purchases food or merchandise. Using a server-assisted amendment flow when connectivity is available or a locally unlocked amendment package when it is not, the application obtains and writes an extension portion and its cryptographic authenticator to the same credential while preserving the first identifier portion. The extension portion encodes access descriptors for specific pickup resources (such as a designated concessions enclosure or merchandise pickup compartment), each with a resource identifier, an operation-type indicating dispense or unlock, validity data (for example, a game-time window or single-use), and an anti-replay value. Awards, promotions, and/or loyalty entitlements associated with the team app's loyalty program can be represented as additional access descriptors with their own validity and usage limits.

At the counter, a reader acquires the token and submits the request. Permission is determined based on validator permission data, token validation, and/or selection of a matching descriptor for the targeted pickup resource and operation. When permitted, a digitally signed key targeted to the resource, constrained to the authorized operation-type and validity window, and bound to an anti-replay value is issued. If the concession fixture lacks reliable network access, the key can be delivered over a bridged path through the reader or the fan's device without altering receiver verification. The receiver validates the key using pre-provisioned information and then instructs a control circuit to release the purchased or promotional item. After redemption, or upon expiration, the application may remove the extension portion while the first identifier portion remains usable for venue entry. Namespace values may additionally be enforced so that keys issued for one venue or tenant do not authorize access at another.

In some embodiments where updating or distributing a new key pair to receivers is impractical or undesirable (for example, at sporting venues or other sites with intermittent or no connectivity), receivers operate using pre-provisioned trust anchors or public keys already present on the receiving end. Authorization may be determined by server-side evaluation when a path to the back end exists, or selection of a matching access descriptor and satisfaction of locally checkable conditions may be performed by a capable application when the back end is unreachable; when connectivity becomes available (directly or via a bridged path through a reader or user device), the digital key server issues a digitally protected key targeted to the resource and operation. Because the receiver verifies that key against its existing trust material—and the key is bound to the selected access descriptor and validity constraints—the system relates the descriptor to the keys already resident at the receiving end, avoiding receiver key updates while maintaining secure operation despite connectivity limitations.

While the foregoing embodiments are described primarily in connection with controlling access to particular resources, the techniques disclosed herein are more generally applicable to manipulation of tokens and credentials in other contexts. In particular, the server-assisted and on-device amendment flows, extension-portion structures, and cryptographic binding mechanisms may be used to add, modify, update, delete, enable, or disable (turn on/off) extension-borne information—such as entitlements, assignments, configuration data, usage limits, or context flags—while preserving the token's preexisting functionality and compatibility with legacy parsers and systems that rely on the first identifier portion. These operations may be performed by rewriting the extension portion in whole or in part, replacing one access descriptor with another, toggling policy flags, rotating validity windows or counters, or removing the extension portion entirely, with the first identifier portion left intact. In this manner, additional or revised information can be introduced, superseded, suspended, or revoked without impairing the token's prior abilities and, in some deployments, without modifying installed readers/validators or requiring continuous network connectivity.

Accordingly, these approaches provide a general mechanism for controlled augmentation and maintenance of token state across systems and are not limited to resource-access use cases.

Components and arrangements described herein are illustrative and need not include every aspect or feature discussed; functions may be omitted, merged, reordered, or distributed across different devices or services as appropriate. Existing products and access systems already in use may be configured, reprogrammed, retrofitted, or otherwise adapted without redesign, and digital keys may be generated or formatted to conform to the capabilities and constraints of the system at hand. Tokens and extension portions may be encoded, transported, stored, and verified using any compatible medium or protocol, and amendment flows may be server-assisted or performed locally depending on available connectivity and policy. Unless expressly stated otherwise, features described for any embodiment may be combined with, substituted for, or omitted from features of any other embodiment while remaining within the scope of the invention.

Although the invention may be described in terms of steps, in some embodiments certain different steps are performed simultaneously by the system although described herein as being different steps. Furthermore, in some embodiments the steps may take place in a sequence different than that described herein below. Thus, various combinations of some or all of the steps identified below may be used in certain embodiments. In addition, while several embodiments describe modifying an existing user authenticator, the methodologies and systems disclosed herein may, where applicable, be used to replace an existing user authenticator with an updated or newly issued user authenticator that stores the amended token and/or capability extension (e.g., with the extension portion and corresponding cryptographic authenticator), without departing from the scope of the present invention.

As described above, systems and methods consistent with the invention provide privacy-preserving, offline-verifiable access control across fixtures, areas, and vehicles. The functionality of the illustrated components may overlap, however, and may be present in fewer or greater number of elements and components. Further, all or part of the functionality of the illustrated elements may co-exist or be distributed among several geographically dispersed locations. For example, each “database” may be embodied as a software component, a hardware component, or a combination of a software component and a hardware component. Moreover, embodiments, features, aspects and principles of the present invention may be implemented in various environments and are not limited to the illustrated environments.

Further, the sequences of events described herein are exemplary and not intended to be limiting. Thus, other process stages may be used, and even with the processes described herein, the particular order of events may vary without departing from the scope of the present invention. Moreover, certain process stages may not be present and additional stages may be implemented. Also, the processes described herein are not inherently related to any particular system or apparatus and may be implemented by any suitable combination of components.

While the invention has been described with respect to specific examples including presently preferred modes of carrying out the invention, those skilled in the art will appreciate that there are numerous variations and permutations of the above described systems and techniques. It is to be understood that other embodiments may be utilized, and structural and functional modifications may be made without departing from the scope of the present invention. Thus, the spirit and scope of the invention should be construed broadly as set forth in the appended claims.

1. A system for amending one or more authorization states of a user authenticator, the system comprising:
a user authenticator that provides a user with first access rights to a first resource, access to the first resource being limited by a first access system; and
a device comprising one or more processors and memory storing instructions that, when executed by the one or more processors, cause the device to:
(i) receive data indicative of a user's altered access rights with respect to a second resource, access to the second resource being limited by a second access system distinct from the first access system; and
(ii) write the data to the user authenticator, or cause the data to be written to the user authenticator, to provide the user authenticator with the altered access rights with respect to the second resource;
wherein the user authenticator is configured to store the data;
wherein, upon presentation of the user authenticator to the second access system, the user authenticator provides the user access rights to the second resource in accordance with the altered access rights; and
wherein, after the writing of the data to the user authenticator, the user authenticator continues to provide the user with the first access rights to the first resource.

2. The system of claim 1, wherein the altered access rights provide increased access to the second resource or decreased access to the second resource.

3. The system of claim 1, wherein the user authenticator stores a token comprising a first identifier portion usable by the first access system and an extension portion appended to the first identifier portion, the extension portion encoding the data indicative of the altered access rights and being usable by the second access system.

4. The system of claim 3, wherein writing the data comprises writing (i) the extension portion encoding the data indicative of the altered access rights and (ii) a cryptographic authenticator generated over at least the first identifier portion and the extension portion to the user authenticator.

5. The system of claim 3, wherein the extension portion comprises an access descriptor comprising a resource identifier identifying the second resource and validity data, and the extension portion is configured to include a plurality of access descriptors for additional resources distinct from the first resource and the second resource.

6. The system of claim 5, wherein each access descriptor further comprises (i) an operation-type indicator identifying an access operation and (ii) an anti-replay value comprising at least one of a nonce or a counter.

7. The system of claim 1, wherein receiving the data comprises receiving an amendment package comprising the data from a server.

8. The system of claim 1, wherein the device is a user device and receiving the data comprises acquiring an amendment package comprising the data locally stored on the device.

9. The system of claim 3, wherein writing the data comprises rewriting, in its entirety, the token stored on the user authenticator such that the rewritten token comprises the first identifier portion and the extension portion.

10. The system of claim 1, wherein the data encodes a single-use or maximum-use count, and the device is further configured to delete at least a portion of the data from the user authenticator when the single-use or maximum-use count has been consumed.

11. A computer-implemented method for amending one or more authorization states of a user authenticator, the method comprising:
providing, with a user authenticator, a user with first access rights to a first resource limited by a first access system;
receiving data indicative of the user's altered access rights with respect to a second resource limited by a second access system distinct from the first access system; and
writing the data to the user authenticator, or causing the data to be written to the user authenticator, to provide the user authenticator with the altered access rights with respect to the second resource;
wherein the user authenticator stores the data;
wherein, upon presentation of the user authenticator to the second access system, the user authenticator provides the user access rights to the second resource in accordance with the altered access rights; and
wherein, after the writing of the data to the user authenticator, the user authenticator continues to provide the user the first access rights to the first resource.

12. The method of claim 11, wherein the altered access rights provide increased access to the second resource or decreased access to the second resource.

13. The method of claim 11, wherein the user authenticator stores a token comprising a first identifier portion usable by the first access system and an extension portion appended to the first identifier portion, the extension portion encoding the data indicative of the altered access rights and being usable by the second access system.

14. The method of claim 13, wherein writing comprises writing (i) the extension portion encoding the data indicative of the altered access rights and (ii) a cryptographic authenticator generated over at least the first identifier portion and the extension portion to the user authenticator.

15. The method of claim 13, wherein the extension portion comprises an access descriptor comprising a resource identifier identifying the second resource and validity data, and the extension portion is configured to include a plurality of access descriptors for additional resources distinct from the first resource and the second resource.

16. The method of claim 15, wherein each access descriptor further comprises (i) an operation-type indicator identifying an access operation and (ii) an anti-replay value comprising at least one of a nonce or a counter.

17. The method of claim 11, wherein receiving the data comprises receiving an amendment package comprising the data from a server.

18. The method of claim 11, wherein the method is performed by a user device and receiving the data comprises acquiring an amendment package comprising the data locally stored on the user device.

19. The method of claim 13, wherein writing the data comprises rewriting, in its entirety, the token stored on the user authenticator such that the rewritten token comprises the first identifier portion and the extension portion.

20. The method of claim 11, wherein the data encodes a single-use or maximum-use count, and the method further comprises deleting at least a portion of the data from the user authenticator when the single-use or maximum-use count has been consumed.

21.-51. (canceled)
